(19) United States
(12) Patent Application Publication
(10) Pub. No.: US 2023/0117229 A1
(43) Pub. Date: Apr. 20, 2023

(54) VEHICLE BATTERY MODULE

(71) Applicants: HYUNDAI MOTOR COMPANY, Seoul (KR); KIA CORPORATION, Seoul (KR)

(72) Inventors: Jin Won Kim, Pyeongtaek-si (KR); Jun Seok Choi, Hwaseong-si (KR)

(73) Assignees: HYUNDAI MOTOR COMPANY, Seoul (KR); KIA CORPORATION, Seoul (KR)

(21) Appl. No.: 17/872,646

(22) Filed: Jul. 25, 2022

(30) Foreign Application Priority Data
Oct. 20, 2021 (KR) 10-2021-0140376

(51) Int. Cl. H01M 10/613; H01M 50/211; H01M 10/625; H01M 10/6556; H01M 50/242; H01M 10/647

(52) U.S. Cl. CPC H01M 10/613; H01M 50/211; H01M 10/625; H01M 10/6556; H01M 50/242; H01M 10/647; H01M 2220/20

(57) ABSTRACT

A vehicle battery module includes battery cells and a plurality of cooling tubes, each provided to correspond to one of the battery cells and disposed either above or below, or both above and below the corresponding one of the battery cells. The battery module includes connectors each connecting one of the battery cells to a corresponding one of the cooling tubes so as to cool the battery cell through the cooling tube. A cartridge is configured to fix positions of the plurality of cooling tubes and a case is coupled to outer sides of the battery cells in a state in which the battery cells, the connectors, and the cartridge are assembled. A cooling pipe is connected to the plurality of cooling tubes so as to supply a cooling medium to each of the cooling tubes.

### CROSS-REFERENCE TO RELATED APPLICATION

This application claims the benefit of and priority to Korean Patent Application No. 10-2021-0140376, filed on Oct. 20, 2021, in the Korean Intellectual Property Office, the disclosure of which is incorporated herein by reference.

### BACKGROUND

### 1. Field of the Disclosure

The present disclosure relates to a vehicle battery module, and more particularly to a vehicle battery module constructed such that a cooling tube is disposed directly on a pouch terrace of a battery cell, thereby reducing cooling loss and enhancing cooling performance.

### 2. Description of the Related Art

Recently, due to the global trend toward reducing carbon dioxide emissions, demand for electric vehicles, which generate driving power by driving a motor with electrical energy stored in an energy storage device such as a battery, to replace typical internal combustion engine vehicles, which generate driving power through combustion of fossil fuels, is significantly increasing.

The performance of electric vehicles is highly dependent on the capacity and performance of a battery, which is an energy storage device that stores electrical energy provided to a driving motor. For this reason, a vehicle battery, which stores the electrical energy supplied to the motor to generate driving power for the vehicle, should have excellent electrical characteristics, such as excellent charging and discharging performance and a long service life. In addition, a vehicle battery should have a high level of mechanical performance sufficient to withstand harsh vehicle traveling conditions such as high temperatures and extensive vibration. Moreover, it is also important to improve the cooling performance of the vehicle battery.

Methods of cooling a conventional vehicle battery module are broadly classified as an air-cooling method or a water-cooling method depending on the cooling medium and are also classified into a direct cooling method or an indirect cooling method depending on the cooling structure. “Direct cooling method” refers to a method in which refrigerant flows directly to the surface of a battery cell and cools the battery cell. “Indirect cooling method” refers to a method in which a separate heat sink is brought into contact with the surface of a battery cell to conduct heat therefrom. The battery cell is cooled by a cooling fin provided on one side of the heat sink and configured to exchange heat.

Here, the direct cooling method needs a flow path gap for the flow of cooled air between battery cells. The indirect cooling method needs a heat sink between battery cells. However, the direct cooling method has a problem in that the flow path gap occupies a large volume and adds weight. The indirect cooling method has a problem in that the heat sink lowers the energy density of the battery.

In addition, the indirect cooling method using a heat sink has a problem in that cooling performance is degraded due to thermal resistance caused by exchange of heat from the battery cell to the heat sink and from the heat sink to a cooling flow path. For this reason, many technological developments have been made recently with the goal of finding a way to improve the cooling performance of the battery cell.

The information disclosed in this Background section is only to enhance understanding of the general background of the disclosure. The Background section should not be taken as an acknowledgement or any form of suggestion that this information forms the related art already known to a person of ordinary skill in the art.

### SUMMARY

Therefore, the present disclosure has been made in view of the above problems. It is an object of the present inventive concept to provide a vehicle battery module constructed such that a cooling tube is disposed directly on a pouch terrace of a battery cell. Thereby, cooling loss may be reduced and cooling performance may be enhanced. A space is formed between a cartridge and the cooling tube so as to prevent damage to a sealing portion in the terrace of the battery cell and to protect the same.

In accordance with the present inventive concept, the above and other objects can be accomplished by the provision of a vehicle battery module. The battery module includes: battery cells; a plurality of cooling tubes, each provided to correspond to one of the battery cells and disposed either above or below, or both above and below the corresponding one of the battery cells; connectors each connecting one of the battery cells to a corresponding one of the cooling tubes so as to cool the battery cell through the cooling tube; a cartridge configured to fix positions of the plurality of cooling tubes; a case coupled to outer sides of the battery cells in a state in which the battery cells, the connectors, and the cartridge are assembled; and a cooling pipe connected to the plurality of cooling tubes so as to supply a cooling medium to each of the cooling tubes.

Each of the cooling tubes may be provided to correspond to one of the battery cells.

The battery cells may be pressed against each other in a surface-to-surface direction. Each of the cooling tubes may be disposed to be spaced apart either upwards or downwards, or both upwards and downwards from a corresponding one of the battery cells so as to form a space between the cooling tube and the battery cell.

The connector may be a pouch that surrounds the battery cell.

The connector may seal the battery cell and may have a shape in which either an upper end portion thereof or a lower end portion thereof, or both the upper end portion and the lower end portion thereof are connected to the cooling tube and surround the cooling tube so as to allow the battery cell to be cooled through the cooling tube.

Each of the cooling tubes may be supported by a cartridge adjacent thereto.

The cartridge may include a plurality of segments including outer segments and inner segments. The outer segments may cover outermost battery cells and the inner segments may cover inner battery cells excluding the outermost battery cells.

Absorption pads configured to absorb swelling of the battery cells may be respectively disposed between an outermost battery cell and an inner battery cell adjacent thereto and between adjacent pair of inner battery cells.

The outer segments and the inner segments may form a rim so that the battery cells are disposed inside the cartridge.

A space may be provided between the outer segment and the inner segment.

A space may be provided between the connector and the case.

The case may cover all of the cooling tubes, the battery cells, the connectors, and the cartridge.

Respective cooling holes may be formed above and below a corresponding one of the battery cells. Each of the cooling tubes may be inserted through a corresponding one of the cooling holes.

An end of the cooling tube and the cooling pipe may be connected by a rubber tube.

### BRIEF DESCRIPTION OF THE DRAWINGS

The above and other objects, features, and other advantages of the present disclosure should be more clearly understood from the following detailed description taken in conjunction with the accompanying drawings, in which:

FIG. 1 is a view illustrating a vehicle battery module according to an embodiment of the present disclosure;

FIG. 2 is a top view of the vehicle battery module according to FIG. 1;

FIG. 3 is a view illustrating a cooling pipe connected to a plurality of cooling tubes and a flow direction of a cooling medium supplied to the cooling pipe;

FIG. 4 is a view illustrating cooling holes, each of which is formed above and below a corresponding one of battery cells, and the direction in which each of cooling tubes is inserted into a corresponding one of the cooling holes;

FIG. 5 is a view illustrating ends of a plurality of cooling tubes connected to a cooling pipe in the battery module; and

FIG. 6 is a view specifically illustrating a rubber tube to which an end of a cooling tube and a cooling pipe are connected.

### DETAILED DESCRIPTION OF THE EMBODIMENTS

Various embodiments are now described more fully with reference to the accompanying drawings, which show only some embodiments of the present disclosure. Specific structural and functional details disclosed herein are merely representative for the purpose of describing the embodiments. The present inventive concept, however, may be embodied in many alternative forms and should not be construed as being limited to the embodiments set forth herein.

Accordingly, while the embodiments of the disclosure are capable of being variously modified and taking alternative forms, embodiments thereof are shown by way of example in the drawings and are described herein in detail. It should be understood, however, that there is no intent to limit the present inventive concept to the particular embodiments disclosed herein. On the contrary, embodiments of the present disclosure include all modifications, equivalents, and alternatives falling within the scope of the inventive concept.

Unless otherwise defined, all terms used herein, which include technical or scientific terms, have the same meanings as those generally appreciated by those of ordinary skill in the art. Terms defined in common dictionaries should be interpreted as having the same meanings as terms in the context of the pertinent technology. These terms should not be interpreted as having ideal or excessively formal meanings unless clearly defined in the specification. When a component, device, element, or the like of the present disclosure is described as having a purpose or performing an operation, function, or the like, the component, device, or element should be considered herein as being “configured to” meet that purpose or perform that operation or function.

A description is now given in detail of embodiments disclosed herein with reference to the accompanying drawings. Like reference numerals in each drawing indicate like members.

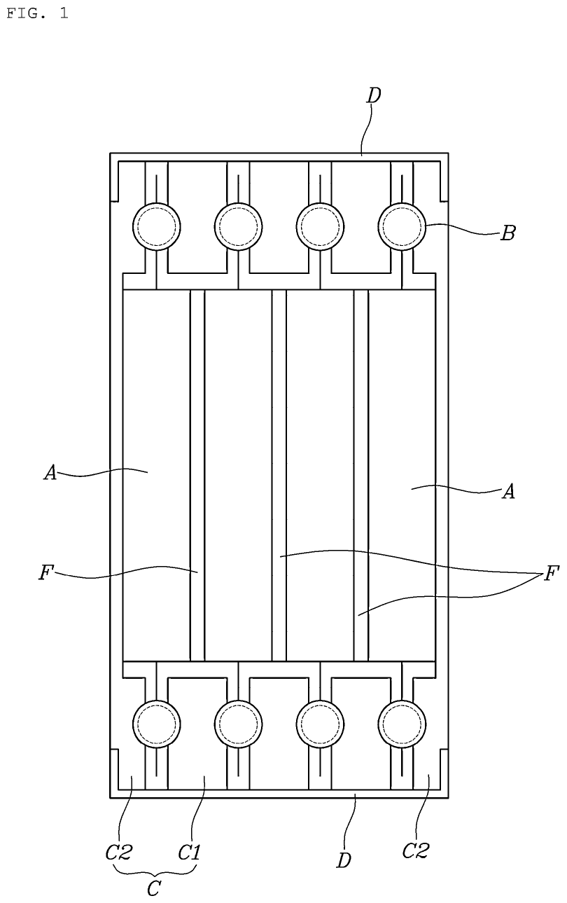

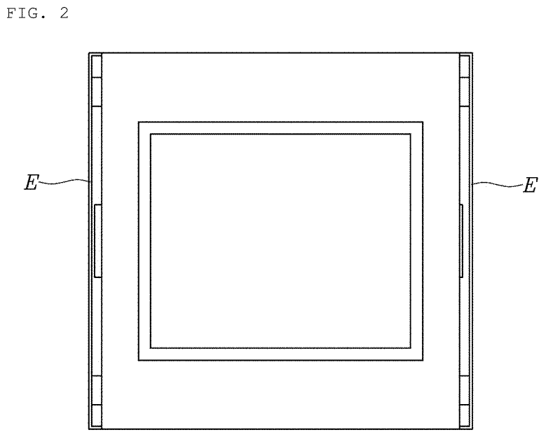

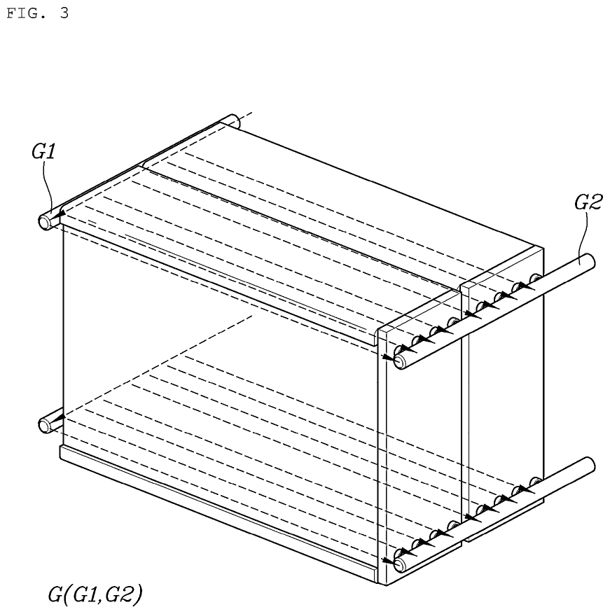

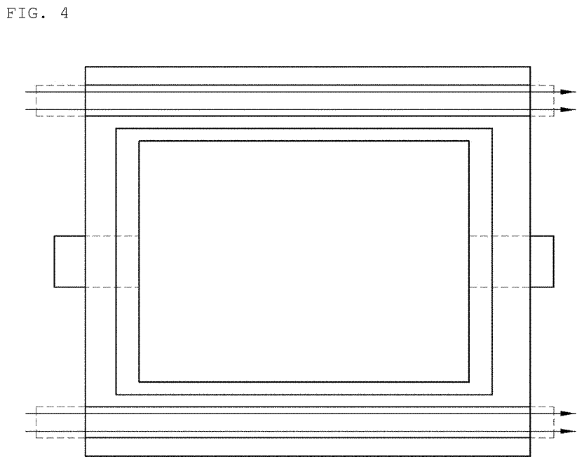

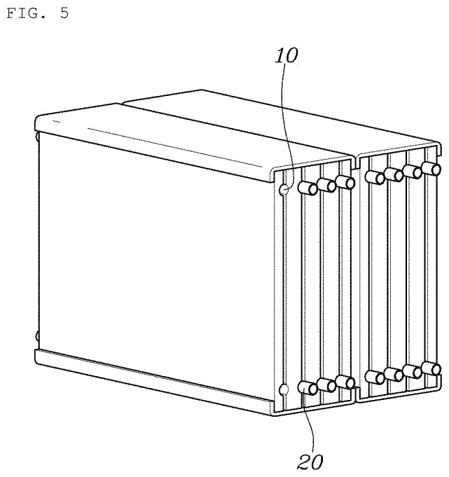

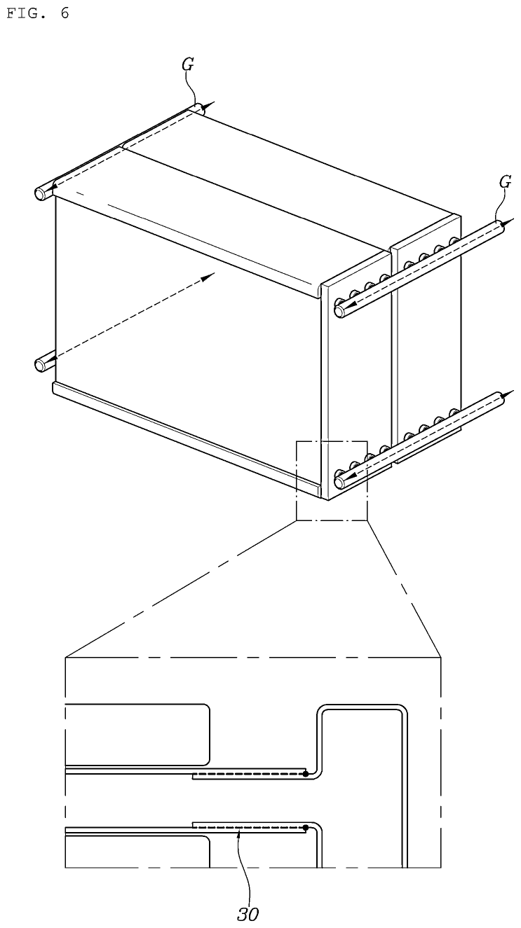

FIG. 1 is a view illustrating a vehicle battery module according to an embodiment of the present disclosure. FIG. 2 is a top view of the vehicle battery module according to FIG. 1. FIG. 3 is a view illustrating a cooling pipe connected to a plurality of cooling tubes and a flow direction of a cooling medium supplied to the cooling pipe. FIG. 4 is a view illustrating cooling holes, each of which is formed above and below a corresponding one of battery cells, and the direction in which each of cooling tubes is inserted into a corresponding one of the cooling holes. FIG. 5 is a view illustrating ends of a plurality of cooling tubes connected to a cooling pipe in the battery module. FIG. 6 is a view specifically illustrating a rubber tube to which an end of a cooling tube and a cooling pipe are connected.

FIG. 1 is a view illustrating a vehicle battery module according to an embodiment of the present disclosure.

Referring to FIG. 1, the vehicle battery module includes a plurality of cooling tubes B, each provided to correspond to one of battery cells and disposed either above or below, or both above and below the corresponding one of the battery cells. The battery module further includes connectors each connecting one of the battery cells A to a corresponding one of the cooling tubes B so as to cool the battery cell A through the cooling tube B. The battery module includes a cartridge C configured to fix positions of the plurality of cooling tubes B and a case D coupled to outer sides of the battery cells A in a state in which the battery cells A, the connectors, and the cartridge C are assembled. The battery module further includes a cooling pipe G connected to the plurality of cooling tubes B so as to supply a cooling medium to each of the cooling tubes B.

In the present disclosure, the cooling tube B is placed directly on a pouch terrace portion of the battery cell A, which constitutes the vehicle battery module, so as to reduce cooling loss and enhance cooling performance. A conventional vehicle battery module is manufactured to have a structure in which an empty space is created inside a terrace area when a battery pouch cell is manufactured. As such, gas generated inside the battery cell A is collected therein, thereby preventing deformation because the gas is present at both electrodes of the battery cell A. Since such a conventional battery module is manufactured for the purpose of collecting and storing gas, the battery module does not communicate with the outside, and is manufactured to form a separate cooling space.

In the conventional battery module formed with a separate cooling space, a flow path gap is formed between the battery cells A in a direct cooling method, which is a cooling method involving the flow of cooled air. Alternatively, the conventional battery module may have a heat sink formed between the battery cells A in an indirect cooling method, which is another cooling method. However, each of the methods has a problem of either increasing the volume and weight or lowering the energy density of the battery. The problems should be overcome by disposing a cooling tube B directly on a pouch terrace portion of the battery cell A.

Specifically, each of the plurality of cooling tubes B is provided to correspond to one of battery cells A and is disposed either above or below, or both above and below the corresponding one of the battery cells A. Referring to FIG. 1, the cooling tube B may be disposed above and/or below the battery cell so as to eliminate the heat generated in the battery cell A. The battery cell A is a pouch-shaped cell type, and the pouch-shaped cell type is manufactured in such a manner that a thin pouch wraps the battery cell A.

In addition, the cooling tubes B are provided such that each cooling tube B corresponds to one of the battery cells A, so that each of the battery cells A can be efficiently cooled through the corresponding one of the cooling tubes B. Each of the cooling tubes B, provided to correspond to one of the battery cells A, may be disposed above and below the corresponding one of the battery cells A so as to reduce cooling loss and further enhance cooling performance.

In addition, each of the battery cells A is manufactured in a pouch-shaped cell type together with a corresponding one of the cooling tubes B. Here, the connector connects each of the battery cells A to a corresponding one of the cooling tubes B. The connector is made of a thermally conductive material so that the battery cells A can be directly cooled through the cooling tubes B. The connector is disposed to vertically penetrate each of the cooling tubes B corresponding to a corresponding one of the battery cells A. The connector is a pouch surrounding the battery cell A. The connector between the battery cell A and the cooling tube B is made of a thermally conductive material, thereby enabling efficient cooling of the battery cells A.

Meanwhile, the battery cells A are pressed against each other in a surface-to-surface direction. Each of the cooling tubes B is disposed to be spaced apart either upwards or downwards, or both upwards and downwards from a corresponding one of the battery cells A so as to form a space between the cooling tube B and the battery cell A. Here, the battery cells A pressed in the surface-to-surface direction form surface pressure with respect to each other, thereby increasing the durability of the battery cells. In addition, since the battery cells A are directly cooled through the space provided between the cooling tubes B and the battery cells A, cooling performance can also be enhanced.

Absorption pads F, configured to absorb swelling of the battery cells A, are respectively disposed between an outermost battery cell A and an inner battery cell A adjacent thereto and between adjacent pairs of inner battery cells A. Here, the absorption pad F is made of a material that is resistant to swelling and to external impacts so as to prevent damage to the battery module due to deformation of the battery cell A.

In addition, the connector seals the battery cell A, and has a shape in which either an upper end portion or a lower end portion thereof, or both the upper end portion and the lower end portion thereof are connected to the cooling tube B and surround the cooling tube so as to allow the battery cell to be cooled through the cooling tube. For cooling of the battery cells A, each of the connectors in the form of a pouch completely seals a corresponding one of the battery cells A. Each of the connectors has a shape surrounding a corresponding one of the cooling tubes B in order to completely remove the heat discharged from each of the battery cells A.

Meanwhile, the cartridge C fixes the positions of the plurality of cooling tubes B. The cartridge includes a plurality of segments including outer segments C2 and inner segments C1. The outer segments C2 cover the outermost battery cells A and the inner segments C1 cover the inner battery cells A excluding the outermost battery cells A. The outer segment C2, which is one of the plurality of segments, is generally provided in two pieces so as to cover the outer surfaces of two outermost battery cells A. The inner segments C1 refer to the remaining segments in the cartridge C, excluding the two outer segments C2.

The cartridge C has a plurality of segments including the outer segments C2 and the inner segments C1, thereby creating a space between the outer segments C2 and the inner segments C1 and ensuring stability. With this configuration, no separate fixing structure configured to fix the battery cell A is needed. When a separate fixing structure is not provided, the cost for separately providing a fixing structure may be eliminated and the overall size of the battery module may be reduced. With the space provided between the outer segments C2 and the inner segments C1, it is possible to accommodate a change in the thickness of the battery cell A and a change in the outer diameter of the cooling tube. The cartridge C is generally made of a material that is easily deformed and easily restored to the original state thereof.

Meanwhile, the outer segments C2 and the inner segments C1 may form a rim so that the battery cells A are disposed inside the cartridge C. The outer segments C2 form a rim to fix the outermost battery cells A, and the inner segments C1 form a rim to fix the inner battery cells A and the cooling tubes B, so that a case D covers the battery module. Therefore, each of the cooling tubes B may be supported by outer segments C2 or the inner segments C1 that are adjacent to the corresponding cooling tube B.

FIG. 2 is a top view of the vehicle battery module according to FIG. 1.

The case D is coupled to outer sides of the battery cells A in the state in which the battery cells A, the connectors, and the cartridge C are assembled.

In FIG. 1, in the state in which the cooling tube B and the connector disposed either above or below, or both above and below the battery cell A are assembled, the case D is coupled thereto from both the top and the bottom. A groove may be formed in the outer segment C2, so that the case D is coupled to the outer side of the battery cell A. In addition, the case D may surround all of the cooling tubes B, the battery cells A, the connectors, and the cartridge C.

The case D is coupled to the upper portion and the lower portion of the battery cells A so as to prevent foreign substances from entering and to protect the battery cells A. Referring to FIG. 2, outer cases E are coupled to the front and the rear of the battery cells A, which are different sides from the sides to which the case D is coupled, so as to prevent foreign substances from entering and to protect the battery cells A.

Meanwhile, a space is provided between the connector and the case D. The space provided between the connector and the case D shares a space provided between the outer segment C2 and the inner segment C1. The space serves to increase the stability of the battery cell A and to prevent damage to the battery cell A.

FIG. 5 is a view illustrating ends of the plurality of cooling tubes B connected to a cooling pipe G in the battery module. FIG. 4 is a view illustrating cooling holes 10 (as illustrated in FIG. 3), each of which is formed above and below the battery cell A. FIG. 4 also illustrates the direction in which each of the cooling tubes B is inserted into a corresponding one of the cooling holes 10.

The cooling pipe G is connected to the plurality of cooling tubes B so as to supply a cooling medium to each of the cooling tubes B. Referring to FIG. 5, the cooling hole 10 is formed above and below the battery cell A and each cooling tube B is inserted through the cooling hole 10 and cools the battery cell A. Each of opposite ends of the cooling tubes B, which are inserted through the cooling hole 10, forms a protrusion 20 protruding outwards. The cooling tubes B and the cooling pipe G may be connected in such a manner that the protrusion 20 formed at the end of the cooling tube B is inserted into the cooling pipe G. Referring to FIG. 4, arrows denote the direction in which the cooling tube B is inserted into the cooling hole 10 and the direction in which a cooling medium including cooling water or air flows in and out.

FIG. 3 is a view illustrating the cooling pipe G connected to the plurality of cooling tubes B and illustrating the flow direction of a cooling medium supplied to the cooling pipe G. The cooling pipe G includes an inlet pipe G1 and an outlet pipe G2. A cooling medium including cooling water or air flows in through the inlet pipe G1, flows through the cooling pipe G, and then flows out through the outlet pipe G2. Meanwhile, the cooling pipe G may be disposed both above and below the battery cell A. When the cooling pipe G is disposed both above and below the battery cell A, the arrangement of the inlet pipe G1 and the outlet pipe G2 disposed above the battery cell A and the arrangement of the inlet pipe G1 and the outlet pipe G2 disposed below the battery cell A may be reversed so as to reduce variation in cooling performance.

FIG. 6 is a view specifically illustrating a rubber tube 30 to which an ends of the cooling tubes B and the cooling pipe G are connected.

The ends of the cooling tubes B and the cooling pipe G may be connected by the rubber tube 30. The rubber tube 30 may be disposed at a portion where the ends of the cooling tubes B and the cooling pipe G are connected so as to prevent leakage of a cooling medium including cooling water or air and to form a sealing structure. When the position of a cooling tube B of a battery cell A is misaligned, the rubber tube 30, disposed at the portion where the end of the cooling tube B and the cooling pipe G are connected, absorbs the tolerance, thereby increasing the durability of the battery cell A and preventing damage to the battery cell A.

Ultimately, in the vehicle battery module, a cooling plate is not provided, but instead, the cooling tube is disposed directly on a pouch terrace of the battery cell. With this structure, the density of volumetric energy may be increased. Due to the simplified shape of the battery module, the manufacturing process of the battery module is simplified, thereby reducing material costs. Further, cooling loss may be reduced and cooling performance may be improved. Moreover, due to the space formed between the cartridge and the cooling tubes, it is possible to protect a sealing portion in the terrace of the battery cell and prevent the same from being damaged.

As should be apparent from the above description, the present inventive concept provides a vehicle battery module constructed such that the cooling tubes are disposed directly on the pouch terrace of the battery cells so as to reduce cooling loss and enhance cooling performance. Due to the space formed between the cartridge and the cooling tubes, damage to the sealing portion in the terrace of the battery cells can be prevented and the sealing portion can be protected.

The effects obtained by the present inventive concept are not limited to the effects mentioned above. Other effects not mentioned should be clearly understood by those of ordinary skill in the art to which the present disclosure pertains from the above description.

Although the embodiments of the present inventive concept have been disclosed for illustrative purposes, those of ordinary skill in the art should appreciate that various modifications, additions, and substitutions are possible without departing from the scope and spirit of the inventive concept as disclosed in the accompanying claims.

What is claimed is:

1. A vehicle battery module comprising:
battery cells;
a plurality of cooling tubes, each provided to correspond to one of the battery cells and disposed either above or below, or both above and below the corresponding one of the battery cells;
connectors each provided to connect a respective one of the battery cell to a corresponding one of the plurality of cooling tubes so as to cool the respective battery cell through the corresponding cooling tube;
a cartridge configured to fix positions of the plurality of cooling tubes;
a case coupled to outer sides of the battery cells in a state in which the battery cells, the connectors, and the cartridge are assembled; and
a cooling pipe connected to the plurality of cooling tubes so as to supply a cooling medium to each of the plurality of cooling tubes.

2. The vehicle battery module according to claim 1, wherein the battery cells are pressed against each other in a surface-to-surface direction, and wherein each of the plurality of cooling tubes is disposed to be spaced apart either upwards or downwards, or both upwards and downwards from a corresponding one of the battery cells so as to form a space between the cooling tube and the corresponding battery cell.

3. The vehicle battery module according to claim 1, wherein each connector is a pouch surrounding one of the battery cells.

4. The vehicle battery module according to claim 1, wherein each connector seals the respective battery cell and has a shape in which either an upper end portion or a lower end portion thereof, or both the upper end portion and the lower end portion thereof are connected to the corresponding cooling tube and surround the corresponding cooling tube so as to allow the respective battery cell to be cooled through the corresponding cooling tube.

5. The vehicle battery module according to claim 1, wherein each of the plurality of cooling tubes is supported by a cartridge adjacent thereto.

6. The vehicle battery module according to claim 1, wherein the cartridge comprises a plurality of segments comprising outer segments and inner segments, wherein the outer segments cover outermost battery cells, and wherein the inner segments cover inner battery cells excluding the outermost battery cells.

7. The vehicle battery module according to claim 6, wherein absorption pads configured to absorb swelling of the battery cells are respectively disposed between an outermost battery cell and an inner battery cell adjacent thereto and between an adjacent pair of inner battery cells.

8. The vehicle battery module according to claim 6, wherein the outer segments and the inner segments form a rim so that the battery cells are disposed inside the cartridge.

9. The vehicle battery module according to claim 6, wherein a space is provided between the outer segment and the inner segment.

10. The vehicle battery module according to claim 1, wherein a space is provided between the connectors and the case.

11. The vehicle battery module according to claim 1, wherein the case covers all of the plurality of cooling tubes, the battery cells, the connectors, and the cartridge.

12. The vehicle battery module according to claim 1, wherein cooling holes are respectively formed above and below a corresponding one of the battery cells, and each of the plurality of cooling tubes is inserted through a corresponding one of the cooling holes.

13. The vehicle battery module according to claim 1, wherein an end of the plurality of cooling tubes and the cooling pipe are connected by a rubber tube.
